(19) United States
(12) Patent Application Publication
(10) Pub. No.: US 2002/0192361 A1
(43) Pub. Date: Dec. 19, 2002

(54) Fabricating technique of a miniature ultraviolet sensor

(75) Inventors: Daniel Chang, Pa-te City (TW); Ming-Tarng Yeh, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: AUDEN TECHNO CORP.

(21) Appl. No.: 10/154,843

(22) Filed: May 28, 2002

Related U.S. Application Data
(63) Continuation of application No. 09/438,413, filed on Nov. 12, 1999.

(51) Int. Cl. B05D 5/12; B05D 3/02

(52) U.S. Cl. 427/58; 427/376.2; 427/374.1

(57) ABSTRACT

The present invention uses an ultraviolet sensitive semiconductor ceramics to fabricate an ultraviolet sensor. For example, adding Sb⁵⁺ to tin dioxide containing Sn⁴⁺ to form SnO₂:Sb. When exposing SnO₂:Sb to ultraviolet rays, the electron Sb⁵⁺ exists in Energy Gap or Forbidden Band being excited, and jumps to Conductive Band, causing the conductivity of SnO₂:Sb to be increased. More electrons are moved to Conductive Band following increasing of ultraviolet intensity, thereby causing the electric resistance value of SnO₂:Sb to be reduced. A film of photosensitive semiconductor ceramics is connected and arranged with driving power, amplifier and control circuit, alarm system, etc., forming a miniature sensor.

### BACKGROUND OF THE INVENTION

The present invention relates to the preparation of an ultraviolet sensor, and more particularly to a miniature ultraviolet sensor fabricating technique which uses an ultraviolet sensitive photosensitive semiconductor ceramics to match with driving power, amplifier and control circuit, alarm system, etc., so as to form a miniature sensor.

Ultraviolet radiation does good and bad effects to living things. For example, ultraviolet radiation can kill bacteria or repress their activation, so as to accelerate the healing of an injury. Ultraviolet radiation also helps the triticeum of skin produce vitamin D to prevent rickets. However, excessive ultraviolet radiation may cause an injury to the skin (which has a concern with the development of skin cancer). Further, excessively opening up virgin forest, consuming petrochemical energy, and abusing Freon and other organic solvents destroy the balance of the nature and damage the protective shield (ozonosphere), causing the ultraviolet rays of the sun directly arrive the earth and endanger human beings and animals. It is important to obtain detector that can show the index or intensity of the ultraviolet rays in the atmosphere, and provide a warning signal when the detected value surpasses a safety range. Followings are to discuss on ultraviolet radiation.

1. Ultraviolet Spectrum:

Ultraviolet radiation is a kind of electromagnetic radiation, its spectrum is between X rays and visible light, and its wavelength is longer than X rays but shorter than visible light. The wavelength of ultraviolet rays is too short to be seen. According to wavelength, ultraviolet spectrum includes near ultraviolet light (4,000˜3,000 Angstrom units), far ultraviolet light (3,000˜2,000 Angstrom units), vacuum ultraviolet light (2,000˜40 Angstrom units), in which the wavelength of Angstrom unit is 10⁻¹¹ M.

2. Ultraviolet Radiation Source:

Ultraviolet radiation may come from the electric arc or carbon arc, the light of a fluorescent lamp, or the light of the sun. About 9% of the energy of sun light is of ultraviolet radiation. Most ultraviolet radiation of the sun is within 4,000˜3,000 Angstrom. Only about 14% of the ultraviolet radiation of the sun is below 3,000 Angstrom. Most ultraviolet radiation of the sun is absorbed by the atmosphere of the earth, however most of the absorbed ultraviolet radiation is of short wavelength. Therefore, among the radiation of sun light, no wavelength shorter than 3,000 Angstrom reaches the surface of the earth. Shorter wavelength of ultraviolet radiation can easily be absorbed by oxygen (O₂), and then converted into ozone (O₃). This is why there is much ozone in the stratosphere.

3. Transmission and Reflection of Ultraviolet Rays:

Similar to visible light, ultraviolet radiation abide by reflection and refraction law of light. It can be transmitted in quartz, fluorescent stones, and distilled water, and absorbed also by substance which is transparent under visible light, such as glass, plastics, etc. Most metal materials (more particularly the materials that have a smooth surface) are good reflector to ultraviolet radiation. The ultraviolet reflecting rate of sands and snow are 17% and 85% respectively. The ultraviolet reflecting rate of water is also high when at a low incident angle. In our living environment, it is not possible to avoid the radiation of ultraviolet rays.

4. Radiation Effect of Ultraviolet Rays:

The radiation of ultraviolet rays accelerate certain chemical reactions, and cause living things to produce the so-called biological effect. A radiation of wavelength shorter than 3,050 Angstrom causes the skin to produce red speckles, and a sedimentation of the color matter of the skin (dark color of the skin). Because the light rays of wavelength between 3,050˜2,900 Angstrom are the lower limit radiation waves that can penetrate the atmosphere, the radiation effect of sun light depends on the condition of the atmosphere. In winter, the light of the sun arrive the earth at an oblique angle, therefore the light path is relatively longer, much energy of the radiation is wasted, and the radiating effect is low. A radiation filtration effect occurs in the morning or evening. Therefore, the effect of darkening the skin by overexposure to the sun will become more apparent when at a high elevation above the sea. Another biological effect of ultraviolet radiation is to favor the triticeum of the skin in producing vitamin D, which can cure and prevent rickets. Further, the radiation of wavelength about 2,600 Angstrom can kill bacteria or repress their activation.

### SUMMARY OF THE INVENTION

The present invention has been accomplished under the circumstances in view.

1. Object of the Present Invention:

The main object of the present invention is to fabricate an economic, effective miniature ultraviolet sensor by designing an ultraviolet sensitive photosensitive semiconductor ceramics to match with servo electronic circuit.

2. Features of the Present Invention.

As indicated above, ultraviolet rays within 3,050˜2,900 Angstrom are the lower limit of the radiation that can penetrate the atmosphere of the earth, and the most harmful wave band to living things. Therefore, an ultraviolet sensor must be designed to mainly detect this range. In order to achieve this requirement, the desired ultraviolet sensor must designed subject to the following two principles:

(1) Accurate Formula

This is the so-called material design. Select proper matrix material and the items of amount of particular additives, enabling the energy of incident photons of designed ultraviolet rays to be greater or equal to the energy of Forbidden Band., such that the electrons at the upper edge of Valence Band and the additive electrons in the Energy Gap can be moved to Conductive Band when excited, causing the conductivity of the material to be increased. According to systematic study and theoretical calulating, strategical selection, and experimental tests, materials sensitize to the wave band within 4,000˜2,000 Angstrom include SnO₂, ZnO, In₂O₃, PbO+Al₂O₃+SiO₂, and CdO+B₂O₃+SiO₂.

(2) Accurate Heat Treatment

This is the heat freatment process of matericals. This heat treatment affects the working stability and surrounding resistance property of the material. Photosensitive semiconductor ceramics are commonly used in the form of a thin or thick films. Normally, photosensitive semiconductor ceramics must be built up on certain compensatory substrates. Therefore, it is a great challenge to obtain a stable, uniform film. Normally, Sputtering Process is adopted for the preparation of a thin film. Printing process, Doctor-Blade Process, Spraying Pyrolysis, or Plasma or Thermal Spraying Process is adopted for the preparation of a thick film. Sintering temperature is suggested within 200˜1000° C.

### BRIEF DESCRIPTION OF THE DRAWINGS

FIG. 1 is a resistance-time curve showing the common trend of the variation of electric resistance of different SnO₂:Sb films during and after radiation by ultraviolet rays according to the present invention.

FIG. 2 is an electronic control circuit for an ultraviolet sensor according to the present invention.

FIG. 3 is a block diagram illustrating a linkage of the ultraviolet sensor to a computer according to the present invention.

FIG. 4 is a voltage-time curve obtained from a relatively thinner SnO₂:Sb film, showing a relatively greater output voltage difference (4V) and a longer recovering time (140 sec.).

FIG. 5 is a voltage-time curve obtained from a relatively thicker SnO₂:Sb film, showing a relatively smaller output voltage difference (0.5V) and a shorter recovering time (16 sec.).

FIG. 6 is a circuit block diagram of an ultraviolet sensor according to the present invention.

FIG. 7 is a detailed circuit diagram of the ultraviolet sensor shown in FIG. 6.

FIG. 8 is flow chart showing the operation of the software program in calculating ultraviolet intensity (I).

FIG. 9 is flow chart showing the operation of the software program in calculating ultraviolet intensity (II).

FIG. 10 is a voltage-time curve obtained from an ultraviolet sensor under different intensity of ultraviolet rays according to EXAMPLE III of the present invention.

FIG. 11 is voltage-time curve obtained from the ultraviolet sensor according to EXAMPLE III of the present invention when repeatedly radiated by a low intensity of ultraviolet rays.

FIG. 12 is voltage-time curve obtained from the ultraviolet sensor according to EXAMPLE III of the present invention when repeatedly radiated by a high intensity of ultraviolet rays.

FIG. 13 is a voltage-time curve obtained from the ultraviolet sensor according to EXAMPLE III of the present invention when repeatedly radiated by the light of the sun.

### DETAILED DESCRIPTION OF THE PREFERRED EMBODIMENT

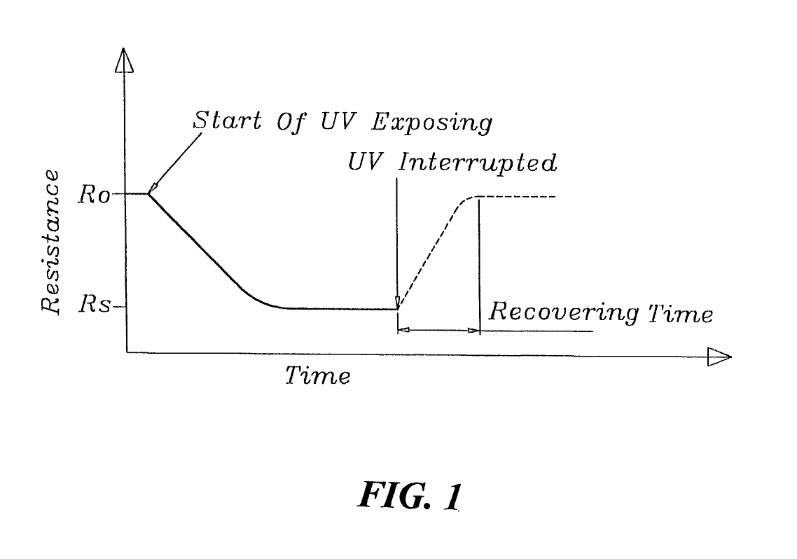

The present invention will now be described in detail by means of examples with reference to the annexed drawings from FIGS. 1 through 13.

### EXAMPLE I

### Fabrication of Ultraviolet Photosensitive Semiconductor Ceramic Film

This example describe the fabrication of an SnO₂:Sb ultraviolet photosensitive film by means of spraying pyrolysis. At first, 5 g SnCl₂ and 0.5 g SbCl₂ are solved in water, forming a 100 cc solution, hereinafter called as Solution A. Because Sn (Tin) and Sb (Antimony) are weak alkaline substance, a hydrolysis occurs when SnCl₂ and 0.5 g SbCl₂ are solved in water, causing a milk-like suspension to be produced. The production of the milk-like suspension causes the variation of the ratio of concentration between Sn and Sb unable to be accurately controlled. In order to eliminate this hydrolysis, 5 cc HCl is added to Solution A, so as to obtain Solution B.

Thereafter, 20 mm×20 mm aluminum oxide plates and 20 mm×20 mm glass plates are heated to 300° C., then Solution A and Solution B are respectively sprayed over the substrates (aluminum oxide plates and glass plates). Sn and Sb ions in Solution A and Solution B are decomposed when heated, thereby causing a SnO₂:Sb film to be adhered to the substrates. Silver glue is then coated on the two opposite ends of each substrate, and then heated to 100° C. to form detecting terminals. When the SnO₂:Sb film at each substrate is respectively radiated by ultraviolet rays, a variation of electric resistance is indicated as follows:

| | | | Resistance (K Ω) at | |
|---|---|---|---|---|
| | | Resistance (K Ω) | 2 minutes after | |
| | Initial Resistance | after radiation of | radiation | |
| Sample | (K Ω) | ultraviolet rays | interrupted | Remark |
| A1 | 1.189 | 1.180 | 1.181 | Sol. A, Aluminum |
| | | | | oxide substrate |
| A2 | 2.210 | 2.100 | 2.101 | Sol. A, Glass |
| | | | | substrate |
| B1 | 1.291 | 1.279 | 1.284 | Sol. B, Aluminum |
| | | | | oxide substrate |
| B2 | 1.085 | 1.078 | 1.081 | Sol. B, Glass |
| | | | | substrate |

As indicated above, the electric resistance of the SnO₂:Sb film from either fabrication procedure drops after radiation of ultraviolet rays, and it recovers gradually when the radiation of ultraviolet rays is stopped (the recovering time varies with its fabrication procedure). Obviously, this kind of film has the function of detecting ultraviolet rays, and can be used for making an ultraviolet sensor.

### EXAMPLE II

### Fabrication of Ultraviolet Sensor (1)

Because the sensitivity to ultraviolet rays of the SnO₂:Sb film changes relative to its fabrication procedure, a modification must be made. For economic consideration, the inexpensive spraying pyrolysis procedure is still adopted. Use 5 g SnCl₂, 0.074 g SbCl₂ and 35 g HCl to prepare a 100 cc water solution. The solution is then sprayed over 300° C. aluminum oxide plates at two times and five times respectively, enabling Sn and Sb ions to be heated and then decomposed, thereby causing a SnO₂:Sb film to be adhered to each aluminum oxide plate at a different thickness. Thereafter, the SnO₂:Sb film coated on aluminum oxide plates are heated in an furnace at 800° C. for 2 hours, causing the SnO₂:Sb film coated on aluminum oxide plate to be more stable. FIG. 1 is a resistance-time curve showing the common trend of the variation of electric resistance of different SnO₂:Sb films during and after radiation by ultraviolet rays. As indicated, the linearity of the electric resistance of each SnO₂:Sb film starts to drop at the initial stage upon radiation of ultraviolet rays, then goes gradually to the saturated set value Rs, then goes upward to the initial value Ro after interruption of the radiation of ultraviolet rays. If UV (ultraviolet) exposing conditions are changed, the electric resistance is changed directly proportional to the intensity of the radiation of ultraviolet rays. However, when under same intensity of ultraviolet rays, the thinner SnO₂:Sb film changes more significantly than the thicker SnO₂:Sb film on electric resistance, but the thicker SnO₂:Sb film changes more significantly than the thinner SnO₂:Sb film on saturated value, and the resistance recovering time of the thicker SnO₂:Sb film is shorter than the thinner SnO₂:Sb film. The characteristics of the film in resistance changing rate and saturated value are used in designing a ultraviolet sensor.

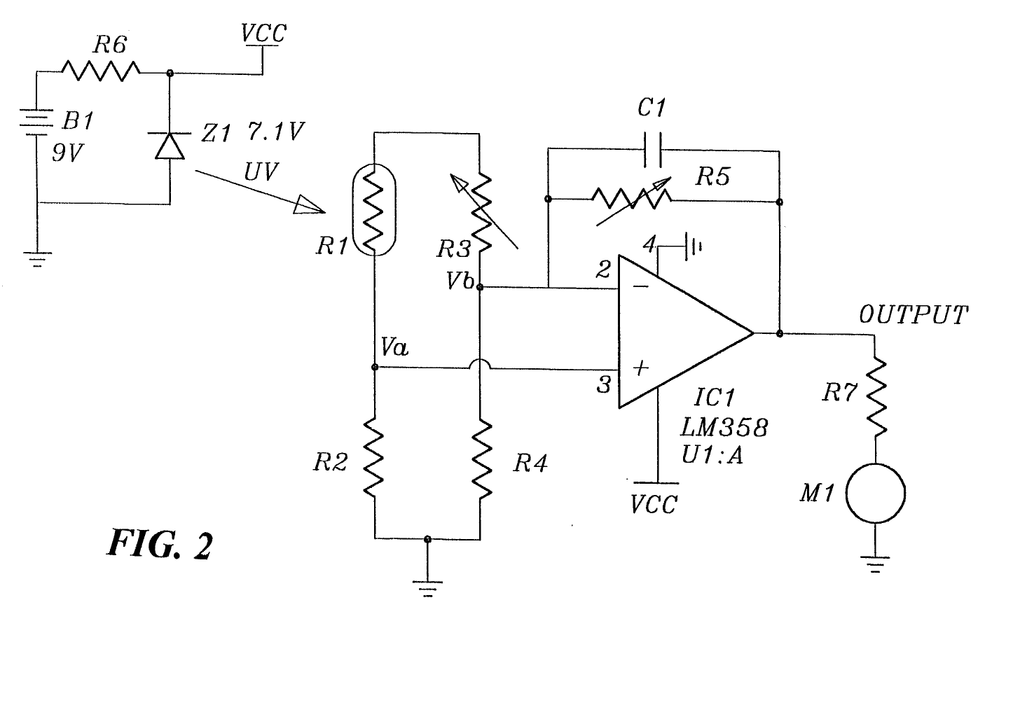

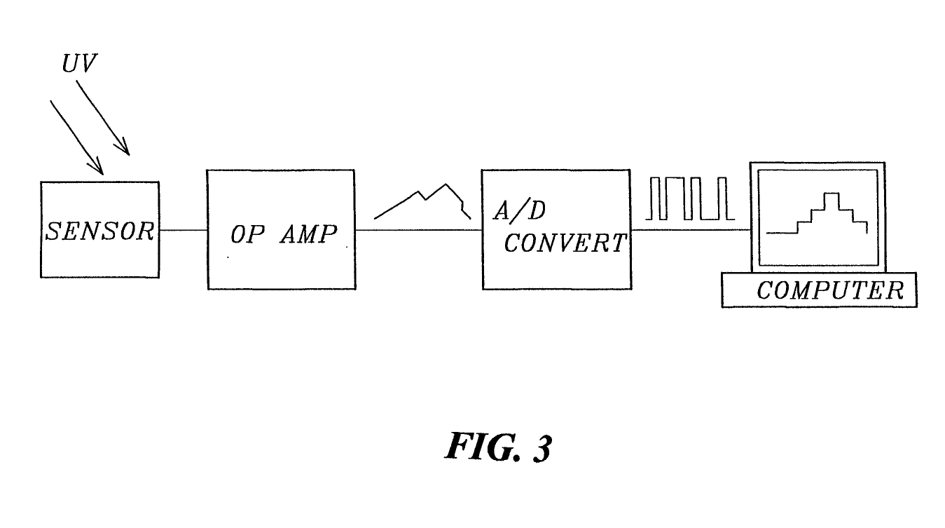

Because the resistance variation amount of the SnO₂:Sb film according to the aforesaid fabrication procedure is not great enough (it has a great concern with the geometric configuration of the test samples), the electronic driving circuit must be specially, designed. FIG. 2 shows an electronic driving circuit for use in an ultraviolet sensor. The electronic driving circuit obtains the necessary working voltage from a 9V battery. Because a voltage variation biases the detection, a zener diode (see the upper left-corner in FIG. 2) is used to stabilize the voltage at about 7V. In FIG. 2, resistors R₁, R₂, R₃, and R₄ form a bridge circuit, resistor R₁ is a detector resistor, resistor R₂ is a variable resistor that can be adjusted externally, resistor R₅ is for adjusting Operating Amplifier LM358, and capacitor C₁ is a high frequency noise filter capacitor. The voltage at point “a” and point “b” are: Va=VccR₂/(R₁+R₂) and Vb=VccR₄/(R₃+R₄) respectively. If Va=Vb, the output voltage is 0V. When the ultraviolet sensor detects the presence of ultraviolet rays, the detector resistor R₁ drops, causing Va>Vb, therefore a differential voltage is produced at the input end of the Operational Amplifier, which is further amplified and then outputted to a indicator or display. An analog-to-digital converter may be used to convert the output signal of the Operational Amplifier into a computer readable signal (digital signal) for output to a computer (see FIG. 3).

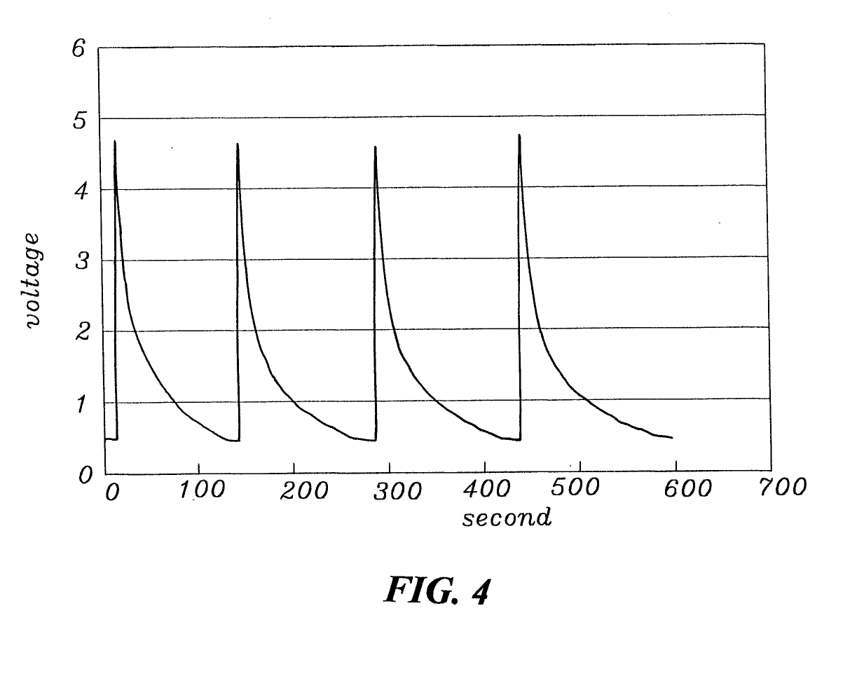

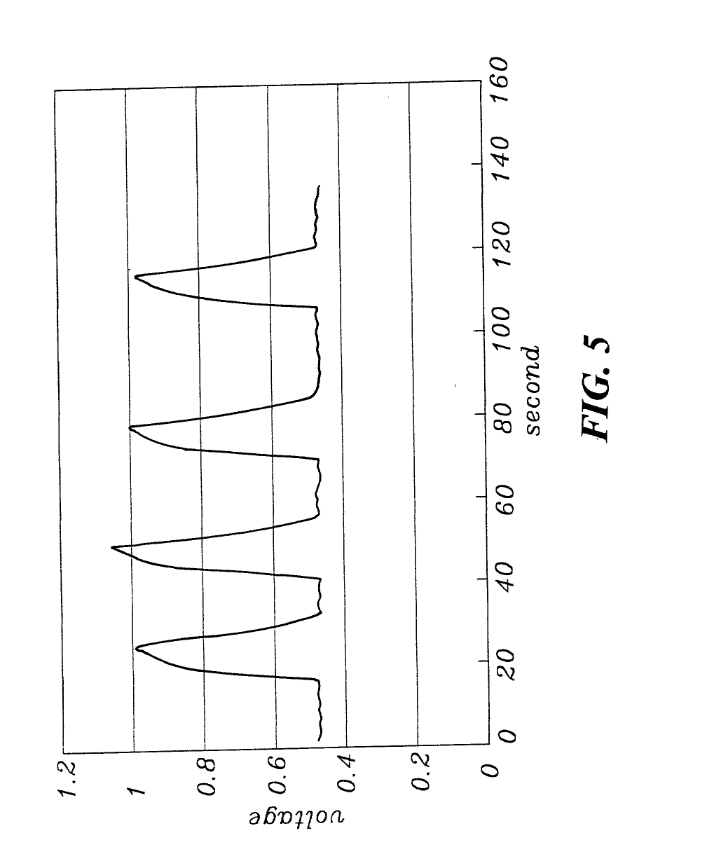

The SnO₂:Sb films which are made by spraying pyrolysis at two times and at five times respectively are exposed to ultraviolet rays, and then detected by means of the circuit shown in FIG. 2 and the circuit shown in FIG. 3, showing a respective voltage variation as indicated in FIGS. 4 and 5. The output voltage difference (4V) of the thinner film is relatively greater, however its recovering time (140 sec.) is relatively longer. On the contrary, the output voltage difference (0.5V) of the thicker film is relatively smaller, however its recovering time (16 sec.) is relatively shorter. This result is similar to the resistance variation shown in FIG. 1.

### EXAMPLE III

### Fabrication of Ultraviolet Sensor (2)

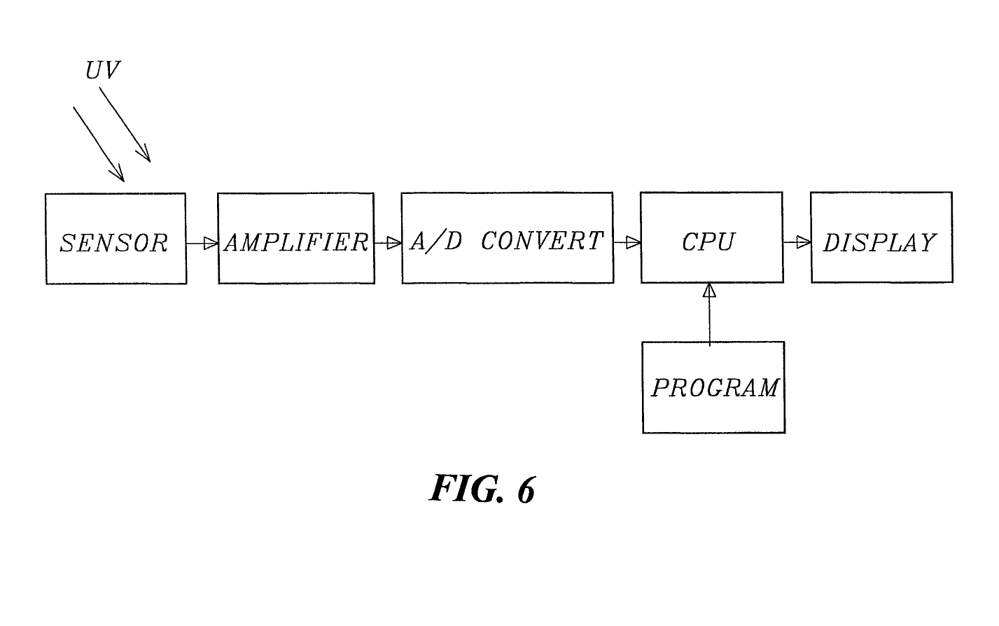

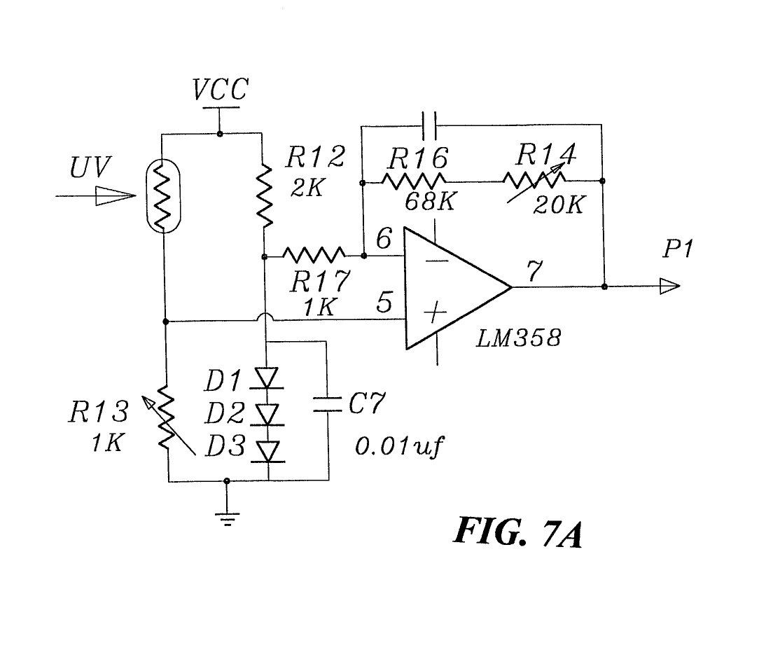

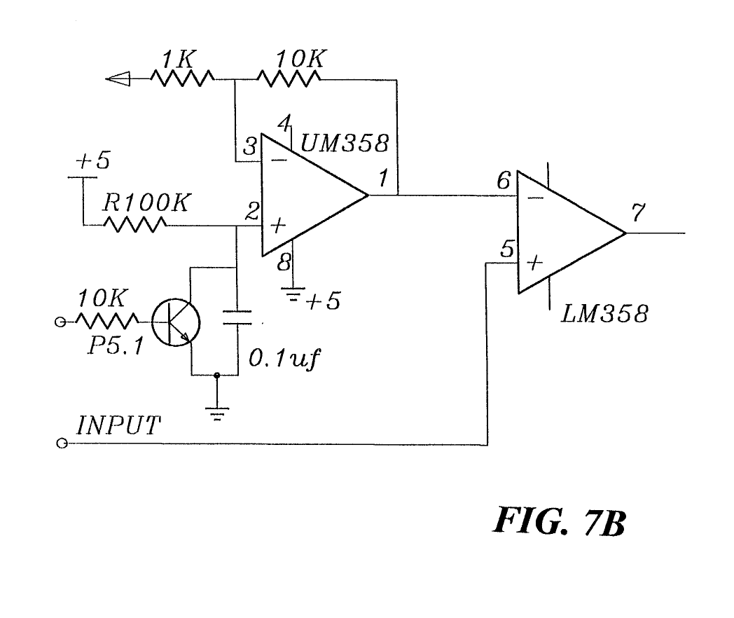

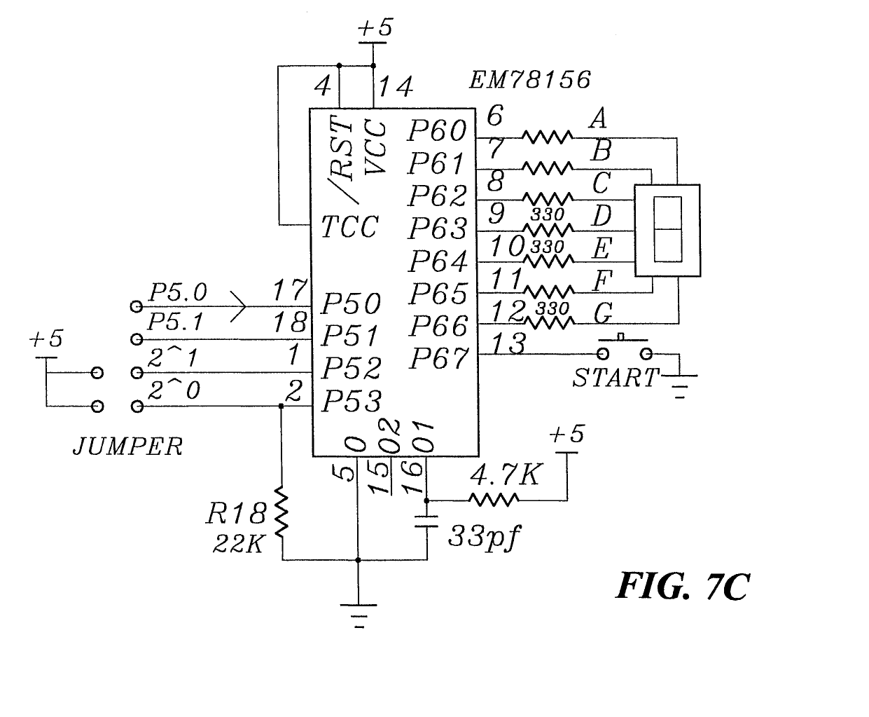

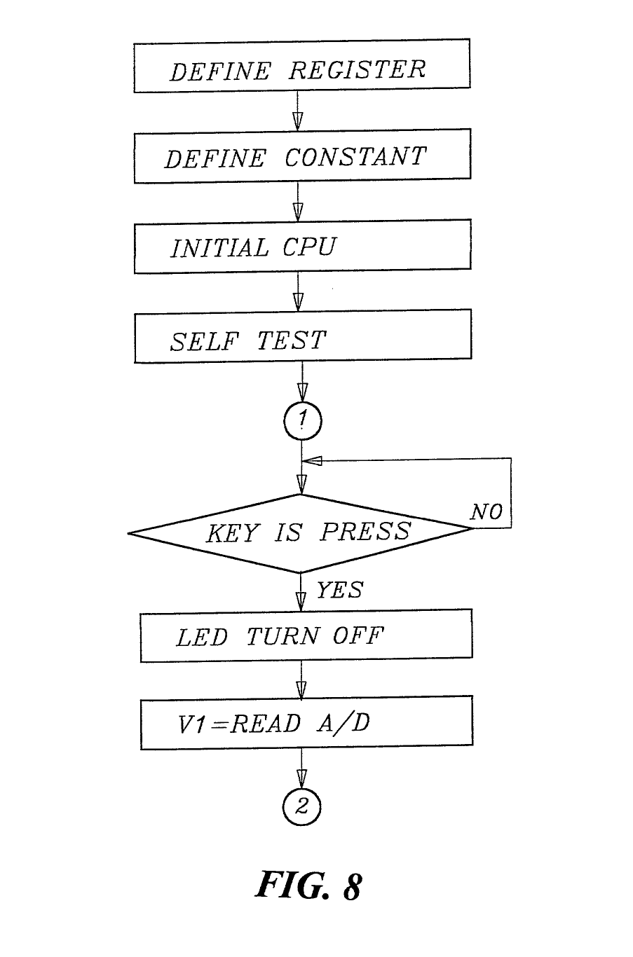

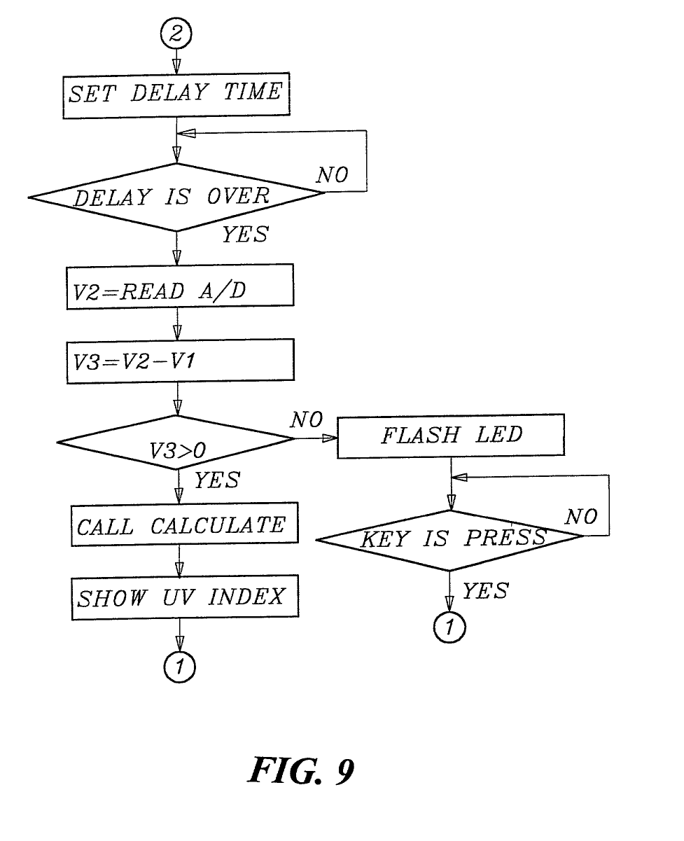

This SnO₂:Sb film fabrication procedure is similar to the aforesaid EXAMPLE II with the exception of heating the SnO₂:Sb film coated on aluminum oxide plates at 600° C. for 3 hours. This circuit block diagram of the UV detector, as shown in FIG. 6, includes six parts, namely, UV sensor (SnO₂:Sb film), signal amplifier, analog-to-digital converter, CPU (central processing unit), software program, and display. When exposed to ultraviolet rays, the resistance variation of the sensor is amplified into a voltage signal by the signal amplifier, then converted into a digital signal by the analog-to-digital converter, and then processed through the CPU into the display readable intensity indicative signal by mcans of the control of the software program, and then outputted to the display. The detailed circuit of this ultraviolet detector is shown in FIG. 7A˜7C, in which the signal amplifier is shown in FIG. 7A, the analog-to-digital converter is shown in FIG. 7B, the CPU and the display are shown in FIG. 7C. FIGS. 8 and 9 are flow chart showing the operation of the software program in calculating ultraviolet intensity.

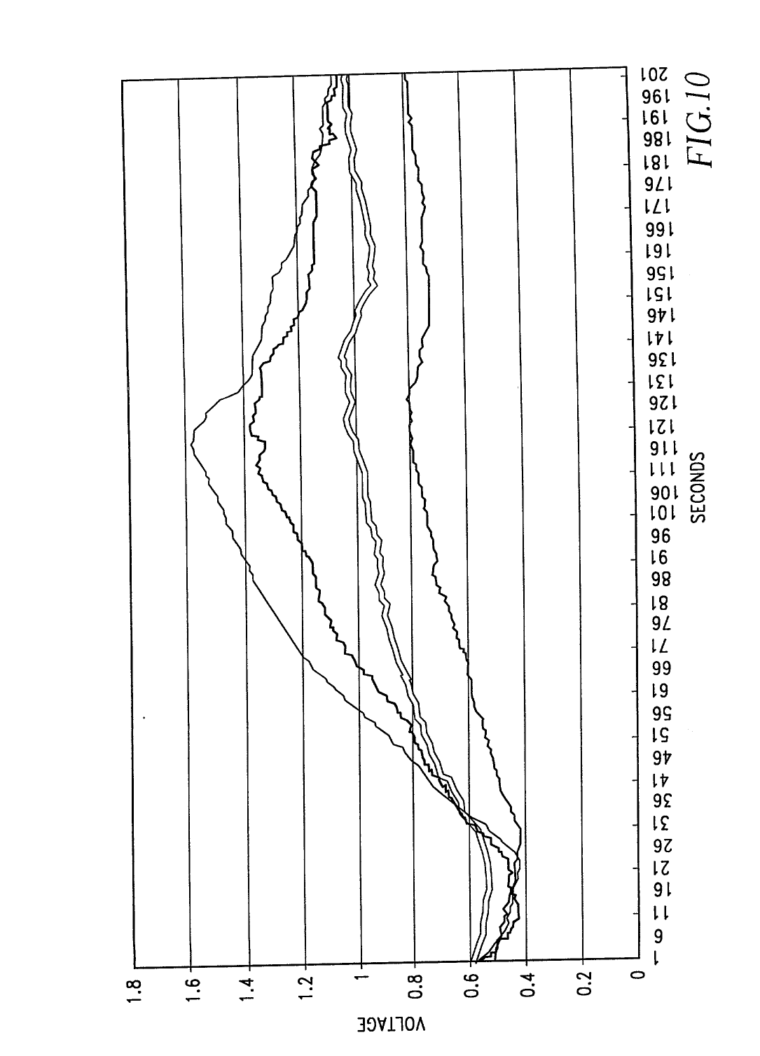

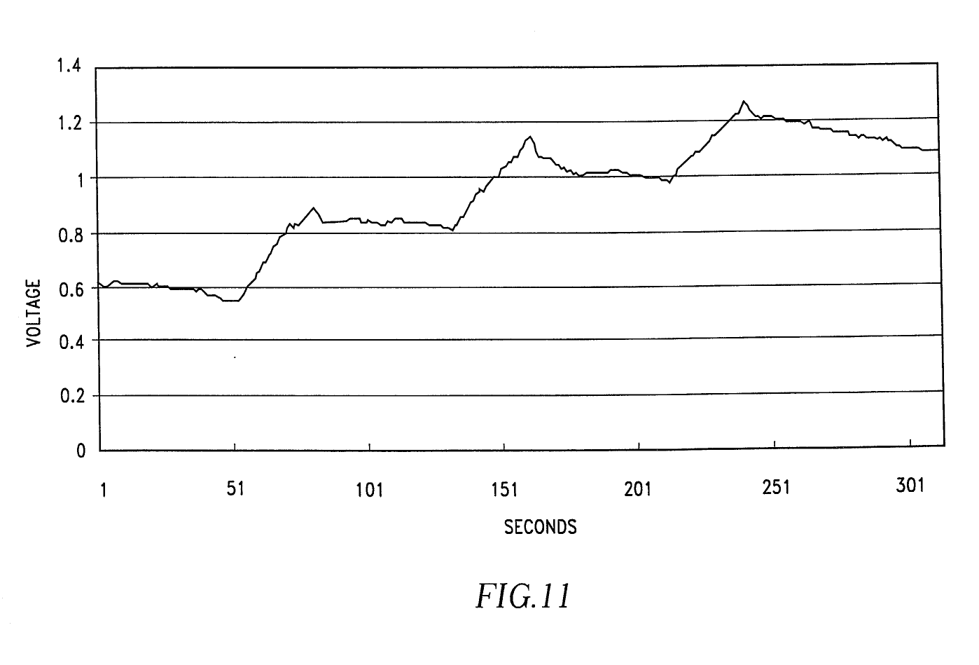

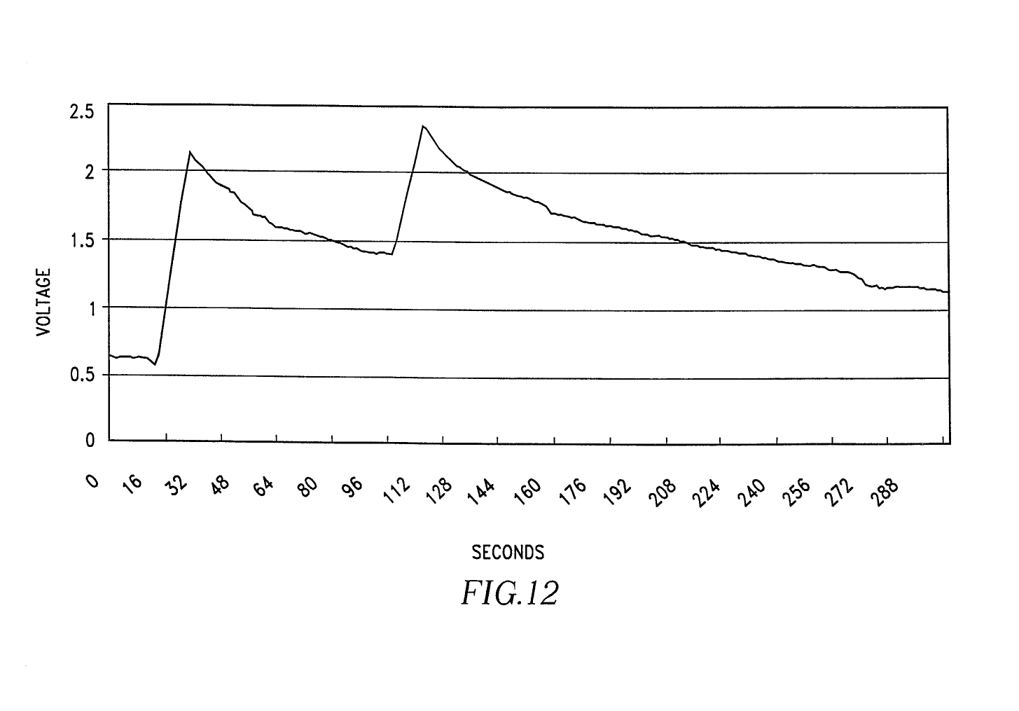

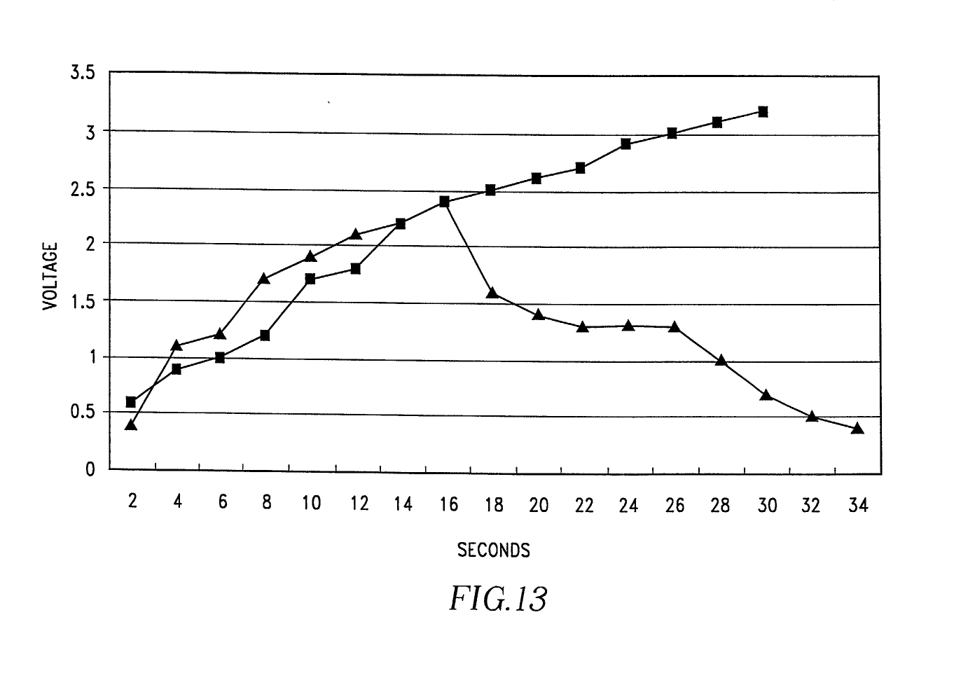

An ultraviolet sensor made according to the aforesaid method is exposed to different intensity of ultraviolet lamps and sun light, and then its effect is measured. FIG. 10 is a voltage-time curve obtained from the ultraviolet sensor under different intensity of ultraviolet rays. As illustrated, the voltage is directly proportional to the intensity of ultraviolet rays and exposing time (the exposing started at 20 seconds, and ended at 121 seconds). FIGS. 11 and 12 are voltage-time curves obtained from the ultraviolet sensor when repeatedly radiated by a low intensity of ultraviolet rays and a high intensity of ultraviolet rays. These curves show that the voltage increasing rate is directly proportional to ultraviolet intensity. FIG. 13 is a voltage-time curve obtained from the ultraviolet sensor when repeatedly radiated by the light of the sun of which the index of ultraviolet rays is 6. This curves indicates that the voltage increasing rate is 0.3V/sec. The above data indicates that the sensor achieves a high performance. When matching with IC fabrication procedure and standard light source to show index intensity, a miniature ultraviolet sensor of high performance and low cost is obtained.

### EXAMPLE IV

### Fabrication of Ultraviolet Detecting Element

According to the aforesaid three ultraviolet detecting film fabrication examples, different fabrication procedures result in different curves reactive to different properties, for example, base resistance value, resistance increasing rate, saturated resistance value, resistance recovering time difference, surrounding resistance, . . . etc. The influential factors are-listed below:

| | Material | | Film | | | Heat |
|---|---|---|---|---|---|---|
| | crystal- | | thick- | Film | Film | treat- |
| Test condition | lization | Additive | ness | length | width | ment |
| Base resistance | ⊚ | ⊚ | ⊚ | ⊚ | ⊚ | ⊚ |
| Resistance | ⊚ | ⊚ | ⊚ | ⊚ | ◯ | ⊚ |
| increasing rate | | | | | | |
| Saturated | ⊚ | ⊚ | ⊚ | ⊚ | ⊚ | ⊚ |
| resistance | | | | | | |
| Recovering time | ⊚ | ⊚ | ⊚ | ◯ | ◯ | ⊚ |
| difference | | | | | | |
| Surrounding | ⊚ | ⊚ | ◯ | | | ⊚ |
| resistance | | | | | | |

If all of the aforesaid factors are taken into account when developing a special or standard fabrication procedure, an element that produces a particular reaction curve after radiation of ultraviolet rays can then be obtained. For example, a resistor having a particular resistance value produces a particular resistance difference value after exposing to particular ultraviolet rays, and returns to its initial resistance value after interruption of ultraviolet radiation. If this kind of driven element is used in an electronic circuit, the electronic circuit can then be influenced or controlled by ultraviolet rays, however its functions are determined subject to design.

The aforesaid ultraviolet ray-controlled film resistor can be connected with film solar battery means (for example, CdTe-CdS), a ultraviolet driving and controlling element is formed, which outputs a particular voltage current value to further drive the whole electronic circuit subject to the intensity of ultraviolet rays.

It is to be understood that the drawings are designed for purposes of illustration only, and are not intended as a definition of the limits and scope of the invention disclosed.

I claim:

1. A method of making an ultraviolet sensor comprising the steps of:
a) heating an aluminum oxide plate to at least 300 C.;
b) forming a film of SnO₂:Sb on the aluminum oxide plate;
c) heating the aluminum oxide plate and SnO₂:Sb film to at least 600° C. for at least 2 hours to stabilize the SnO₂:Sb film; and,
d) cooling the aluminum oxide plate and the SnO₂:Sb film to thereby form an ultraviolet sensor in which an electrical resistance varies upon exposure of the SnO₂:Sb film to ultraviolet light having a band width of between 2,000˜4,000 Angstroms.

2. The method of making an ultraviolet sensor set forth in claim 6 wherein the step of forming a film of SnO₂:Sb comprises the additional step of:
a) mixing 5 g SnCl₂, 0.074 g SbCl, 35 g HCl and water to form a 100 cc water solution; and,
b) spraying the water solution on the heated aluminum oxide plate at least twice.

3. The method of making an ultraviolet sensor set forth in claim 7 wherein the water solution is sprayed on the heated aluminum oxide plate five times.

4. The method of making an ultraviolet sensor set forth in claim 6 wherein the aluminum oxide plate and SnO₂:Sb film are heated at 800° C. for 2 hours.

5. The method of making an ultraviolet sensor set forth in claim 6 wherein the aluminum oxide plate and SnO₂:Sb film are heated at 600° C. for 3 hours.
